(19) United States
(12) Patent Application Publication
(10) Pub. No.: US 2026/0308843 A1
(43) Pub. Date: Oct. 8, 2026

(54) IMAGE ASSIGNMENT SYSTEM FOR ASSIGNING IMAGE TO AT LEAST A PARTIAL REGION IN A WIDTH DIRECTION OF A TRANSFER TARGET, AND IMAGE ASSIGNMENT SYSTEM FOR ASSIGNING AN IMAGE TO FABRIC

(71) Applicant: MIMAKI ENGINEERING CO., LTD., Nagano (JP)

(72) Inventors: Tomohiko Takizawa, Nagano (JP); Yasuhiro Hida, Nagano (JP); Nobuyasu Usui, Nagano (JP); Naoshi Watanabe, Nagano (JP); Hirokazu HAYASHI, Nagano (JP)

(73) Assignee: MIMAKI ENGINEERING CO., LTD., Nagano (JP)

(21) Appl. No.: 19/164,219

(22) PCT Filed: Jun. 5, 2024
(86) PCT No.: PCT/JP2024/020487

§ 371 Date: Sep. 11, 2025

(30) Foreign Application Priority Data
Jun. 5, 2023 (JP) 2023-092772
Jun. 5, 2023 (JP) 2023-092774

(51) Int. Cl. D06P 5/24; B41J 11/00; D06P 5/30

(52) U.S. Cl. CPC D06P 5/003; B41J 11/0022; B41J 11/00244; D06P 5/30

(57) ABSTRACT

Provided is an image assignment system for assigning an image to at least a partial region of a transfer target in a width direction of the transfer target having a width of 500 mm or more. The image assignment system includes: a transfer body that includes a base layer and a transfer layer formed on one surface of the base layer; a printing device that prints the image on the transfer layer by an inkjet method using ink containing a coloring material; and a transfer device that transfers the image printed on the transfer layer to the transfer target by overlaying the transfer body with the transfer target and applying heat and pressure. The transfer layer includes a thermoplastic resin that softens in response to reaching a glass transition temperature or a melting point.

### TECHNICAL FIELD

The present invention relates to an image assignment system for assigning an image to at least a partial region in a width direction of a transfer target, and an image assignment system for assigning an image to fabric.

### RELATED ART

As conventional techniques for printing images such as patterns on fabric, there are sublimation transfer printing method, direct sublimation printing method, DTG (Direct To Garment), DTF (Direct To Film) printing method, and rubber transfer printing method.

In the sublimation transfer printing method, an inverted image is printed on transfer paper using disperse dye, and the transfer paper is overlaid with polyester fabric and heat and pressure are applied to transfer the image from the transfer paper to the fabric.

In the direct sublimation printing method, transfer paper is not used, and an image is directly printed on polyester fabric that has been coated with sizing to prevent ink bleeding, and then the fabric is subjected to a heater for color development.

In the DTG printing method, an image is directly printed on fabric such as garments using pigment ink, and color development and ink fixing are performed using a heat press machine or the like. Depending on the type or color of the fabric, a pretreatment agent is applied and fixed with a heat press machine, and then printing is performed using pigment ink.

In the DTF printing method, an inverted image is printed with color ink on a transfer body of plastic film, a concealing layer is formed with white ink on the image layer, hot melt resin powder is sprinkled as an adhesive on the concealing layer, and then this transfer body is overlaid with leaf media such as T-shirts and heat and pressure are applied to transfer the image from the transfer body to the fabric. After that, the transfer body is peeled from the fabric.

In the rubber transfer printing method, an image is printed on the other surface of a rubber sheet with an adhesive layer applied to one surface and attached to a backing paper, the rubber sheet together with the backing paper is cut to a size slightly larger than the image. Then the backing paper is peeled off, and the rubber sheet is overlaid with fabric such as leaf media such that the adhesive layer contacts the fabric, and heat and slight pressure are applied to adhere the rubber sheet to the fabric. After that, finishing press is performed to completely attach the rubber sheet to the fabric.

Also, Patent Document 1 discloses a transfer sheet capable of printing an image on a transfer body using ink containing coloring materials other than disperse dye, unlike the sublimation transfer printing method and direct sublimation printing method, and capable of printing an image on the surface to be adhered to fabric, unlike the DTF printing method and rubber transfer printing method.

### CITATION LIST

### Patent Literature

Patent Document 1: US Patent Application Publication No. 2022/0169068

### SUMMARY OF INVENTION

### Technical Problem

In the sublimation transfer printing method and direct sublimation printing method, coloring materials are limited to disperse dye and other coloring materials cannot be used, and the fabric to which images are applied is not only limited to polyester fabric, but various pretreatments and post-treatments are required for color development of the dye and fixation of the dye to the fabric, making it inefficient. Moreover, such treatments generate large amounts of waste liquid, which may adversely affect the environment and human body. Particularly, in the case of the direct sublimation printing method, in devices using belt transport, since ink bleeds through to the back (seeps to the back side of the fabric) in response to printing on the fabric, a belt cleaning mechanism is required. Also, in this case, it is necessary to periodically apply and clean a chemical called a ground adhesive on the belt to make the fabric adhere closely to the belt, and generation of solvent odor from chemicals and generation of large amounts of contaminated water from cleaning are unavoidable.

In the DTG printing method, it is necessary to apply pretreatment agent according to the type and color of the fabric, and in the case of the pretreatment agent not being applied uniformly to the fabric, the finish may be affected. Also, application traces and odor of the pretreatment agent may remain on the fabric. Also, similar to the direct sublimation printing method, it becomes necessary to clean the platen due to ink bleed-through, etc., and contaminated water is generated. For this reason, the DTG printing method is also inefficient and may adversely affect the environment and human body.

In the DTF printing method, in addition to printing an image on the transfer body, it is necessary to form a concealing layer and sprinkle hot melt resin powder as an adhesive, making the work process complicated and inefficient. Furthermore, the powder may cause generation of dust during printing, which may adversely affect the environment and human body.

In the rubber transfer printing method, in addition to printing an image on the rubber sheet, it is necessary to cut off excess rubber sheet and perform finishing press, making the work process complicated and inefficient.

According to the transfer sheet described in Patent Document 1, unlike the sublimation transfer printing method and direct sublimation printing method, materials other than disperse dye may be used as coloring materials, and unlike the DTF printing method and rubber transfer printing method, a transfer sheet with an image printed thereon may be provided simply. However, an image assignment system that efficiently assigns images to fabric with large width using such transfer sheets was not known.

In view of the above, the present invention aims to provide an image assignment system that efficiently assigns images to at least a partial region in a width direction of a transfer target such as fabric with large width.

Also, according to the transfer sheet described in Patent Document 1, unlike the sublimation transfer printing method and direct sublimation printing method, ink containing coloring materials other than dyes may be utilized. Also, unlike the DTF printing method and rubber transfer printing method, it is suitable for scale printing. However, an image assignment system capable of printing images on fabric on a large scale using such transfer sheets without adversely affecting the environment and human body, or while suppressing adverse effects, was not known.

In view of the above, the present invention aims to provide an image assignment system capable of printing images on fabric on a large scale without adversely affecting the environment and human body, or while suppressing adverse effects.

### Solution to Problem

An image assignment system according to a first aspect of the present invention that assigns an image to at least a partial region of a transfer target in a width direction of the transfer target is:
an image assignment system that assigns an image to at least a partial region in a width direction of a transfer target having a width of 500 mm or more; the image assignment system including:
a transfer body that includes a base layer and a transfer layer formed on one surface of the base layer;
a printing device that prints the image on the transfer layer by an inkjet method using an ink containing a coloring material; and
a transfer device that transfers the image printed on the transfer layer to the transfer target by overlaying the transfer body with the transfer target and applying heat and pressure, in which
the transfer layer includes a thermoplastic resin that softens in response to reaching a glass transition temperature or a melting point.

According to the above configuration, for example, part or all of the complicated processing conventionally required in response to transferring an image to a transfer target such as fabric can be omitted, so an image can be efficiently assigned to the transfer target.

The ink further includes a solvent, in which
the printing device may further include a drying mechanism that dries the transfer body on which the image is printed by evaporating the solvent.

According to the above configuration, for example, after the ink lands on the transfer body, bleeding of the ink in the image printed on the transfer body can be suppressed by volatilizing the solvent of the ink. This reduces the defect rate, so an image can be efficiently assigned to the transfer target.

The drying mechanism may include a heating heater part that contacts and heats the transfer body from a lower surface thereof in at least a partial region on a transport path of the transfer body during printing of the image, or an air drying part that dries by blowing air onto an upper surface of the transfer body against at least a partial region of the transfer body.

According to the above configuration, for example, an image can be efficiently dried with a simple configuration, so an image can be efficiently assigned to the transfer target.

The drying mechanism may dry the image to such an extent that the ink constituting the image does not adhere to an other surface between when the printing device prints the image on the transfer body and when the transfer body contacts the other surface.

According to the above configuration, for example, the image is suitably dried in the case of winding the transfer body into a roll shape or in the case of transporting the transfer body to the transfer device after printing by the printing device, so show-through of ink in the roll of the transfer body and color transfer from the transfer body to the transport mechanism during transport can be suppressed or prevented. Also, since the ink is suitably dried before winding and transport, there is no need to separately provide time for natural drying of the ink, which saves time and allows an image to be efficiently assigned to the transfer target.

The at least a partial region on the transport path of the transfer body may be a region where the ink lands on a surface of the transfer body.

According to the above configuration, for example, the image is suitably dried in the case of winding the transfer body into a roll shape or in the case of transporting the transfer body to the transfer device after printing by the printing device, so show-through of ink in the roll of the transfer body and color transfer from the transfer body to the transport mechanism during transport can be suppressed or prevented. Also, since the ink is suitably dried before winding and transport, there is no need to separately provide time for natural drying of the ink, which saves time and allows an image to be efficiently assigned to the transfer target.

In the at least a partial region on the transport path of the transfer body, the ink may be dried simultaneously as it lands on the surface of the transfer body.

According to the above configuration, for example, bleeding of ink in an image printed on the transfer body can be suppressed or prevented. This reduces the defect rate, so an image can be efficiently assigned to the transfer target.

The at least a partial region on the transport path of the transfer body may be a region before the ink is discharged onto a surface of the transfer body.

According to the above configuration, for example, drying of the subsequent transfer body can be promoted, so drying efficiency is improved, which saves time and allows an image to be efficiently assigned to the transfer target.

The transfer target may be a sheet of natural fiber or synthetic fiber.

According to the above configuration, for example, the transferred image adheres or bonds more firmly to the transfer target by reaction between reactive groups contained in the natural fiber or synthetic fiber and the reactive polymer contained in the transfer layer. This reduces the defect rate, so an image can be efficiently assigned to the transfer target.

The ink is a water-based ink, in which
the coloring material may be an inorganic pigment or an organic pigment.

According to the above configuration, for example, part or all of the complicated processing that was conventionally required in the case of using conventional printing ink such as sublimation ink can be omitted, so an image can be efficiently assigned to the transfer target.

The transfer device may perform transfer by applying a temperature higher than the glass transition temperature or the melting point of the thermoplastic resin of the transfer layer.

According to the above configuration, for example, transfer can be performed reliably, so the defect rate is reduced and an image can be efficiently assigned to the transfer target.

Moreover, an image assignment system for assigning an image to fabric according to a second aspect of the present invention is:
an image assignment system for assigning an image to fabric, the image assignment system including:
a transfer body that includes a base layer and a transfer layer formed on one surface of the base layer;
a printing device that prints the image on the transfer layer by an inkjet method using a water-based ink containing a coloring material; and
a transfer device that transfers the image printed on the transfer layer to the fabric by overlaying the transfer body with the fabric, in which
the transfer layer includes a thermoplastic resin that softens in response to reaching a glass transition temperature or a melting point.

According to the above configuration, in response to assigning an image to fabric, harmful waste liquid or dust is not generated and complicated processing steps are also unnecessary, so it becomes possible to print images on fabric on a large scale without causing adverse effects on the environment or human body or while suppressing adverse effects.

The fabric, the transfer body, and the water-based ink may be ZDHC-MRSL Level 3 compliant.

According to the above configuration, it becomes easy to make products made from fabric having an image assigned thereto ZDHC-MRSL Level 0 to 3 compliant, particularly ZDHC-MRSL Level 3 compliant.

After separating the fabric from the transfer body after transfer,
no step of using water on the fabric or no step of discharging water need to be performed.

According to the above configuration, in response to assigning an image to fabric, harmful waste liquid is not generated and complicated processing steps are also unnecessary, so it becomes possible to print images on fabric on a large scale without causing adverse effects on the environment or human body or while suppressing adverse effects.

The fabric may be natural fiber or synthetic fiber.

According to the above configuration, for example, reactive groups contained in natural fiber or synthetic fiber react with thermoplastic resin, such that the transferred image adheres or bonds to the fabric more firmly. As a result, the defect rate drops, so images can be efficiently assigned to fabric, and scale printing becomes easy.

The fabric may be an inorganic pigment or an organic pigment.

According to the above configuration, for example, in the case of using conventional printing ink such as sublimation ink, part or all of the complicated processing that was conventionally required can be omitted, so images can be efficiently assigned to fabric, and scale printing becomes easy.

### Effects of Invention

According to the present invention, images can be efficiently assigned to transfer targets such as fabric.

Also, according to the present invention, it becomes possible to print images on fabric on a large scale without causing adverse effects on the environment or human body or while suppressing adverse effects.

### BRIEF DESCRIPTION OF DRAWINGS

FIG. 1 is a cross-sectional schematic diagram of transfer body and transfer target. (a) shows the transfer body before an image is printed, (b) shows the transfer body after an image is printed, (c) shows the transfer body and transfer target during thermal transfer, and (d) shows the transfer body and transfer target after peeling following completion of thermal transfer.

FIG. 2 is a schematic diagram of the image assignment system according to the present embodiment.

FIG. 3 is a schematic diagram of the image assignment system according to a modification example.

### DESCRIPTION OF THE EMBODIMENTS

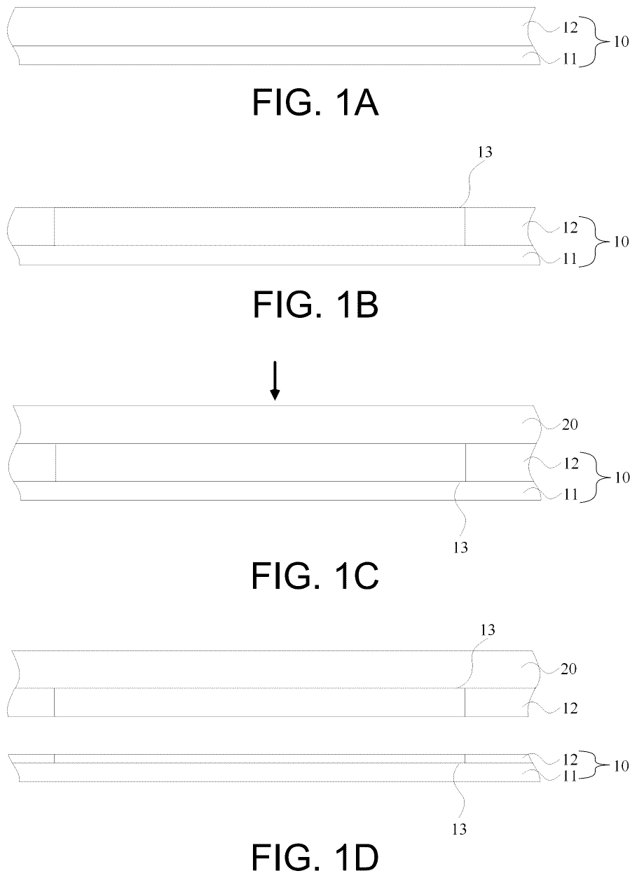

An image assignment system 100 according to one embodiment of the present invention will be described with reference to the drawings. The image assignment system 100 is a system for assigning an image to at least a partial region on a transfer target 20 by thermally transferring an inverted image printed by an inkjet method on a transfer body 10 onto the transfer target 20, as shown in FIG. 1(a) to (d). In this specification, an image is not limited to photographic or elaborate patterns, but includes simple patterns, solid patterns in one color, character patterns, and the like.

### Configuration of Transfer Body 10

The transfer body 10 is a sheet-shaped transfer medium and may be wound into a roll shape for storage and transportation. In this specification, a sheet includes a film. The width of the transfer body 10 in the case of being wound into a roll shape is preferably equal to or less than the width of the transfer target 20 in the case of being wound into a roll shape, and is preferably 500 mm or more and 1800 mm or less. As shown in FIG. 1(a), the transfer body 10 includes a base layer 11 and a transfer layer 12 formed on one surface of the base layer 11.

The base layer 11 is a sheet composed of any material. For example, materials for the base layer 11 include paper, cloth, plastic, and the like. The substrate 11 preferably has air permeability, particularly to assist drying of ink printed on the transfer layer 12. Such base layers 11 include cellulose-based paper, non-woven fabric sheets, fleece sheets, porous films, and the like.

As shown in FIG. 1(b), the transfer layer 12 is a layer on which an image may be printed with ink and which may be adhered onto the transfer target 20 together with the image, as shown in FIG. 1(d). Hereinafter, the portion of the transfer layer 12 that absorbs ink and constitutes an image is referred to as an image layer 13. The transfer layer 12 may also be said to endow an ink receiving layer used in inkjet printing media with adhesive capability to the transfer target 20. Therefore, the transfer layer 12 includes a thermoplastic resin that softens in response to reaching a glass transition temperature or melting point. Such thermoplastic resins include polyethylene, polypropylene, polyamide, and the like. The transfer layer 12 may also preferably include a reactive polymer having reactivity with fabric, more preferably a crosslinkable polymer, particularly a self-crosslinkable polymer. Such reactive polymers include, for example, polyethyleneamine, isocyanate, carbodiimide, and zirconium ammonium carbonate.

Natural fiber includes reactive groups that react with such reactive polymers, for example, hydroxyl groups, ammonium groups, and the like. Such reactive groups are considered to be derived from protein components and/or polysaccharide components such as cellulose, hemicellulose, and keratin included in natural fiber. The reaction between these reactive groups and the reactive polymer improves the adhesion or bonding of the coloring material included in the ink to the natural fiber. In particular, cotton has good reactivity with reactive polymers such as isocyanate, carbodiimide, and zirconium ammonium carbonate because the cellulose constituting it includes hydroxyl groups.

The transfer layer 12 may further include a binder, rheology modifier, pigment, defoaming agent, wetting agent, and the like.

In the case of thermally transferring an image from the transfer body 10 to the transfer target 20, first, as shown in FIG. 1(c), with the transfer layer 12 on which the image layer 13 is formed in contact with the transfer target 20, the transfer body 10 is pressed against the transfer target 20 while being heated and pressure is applied. Thereafter, in response to peeling the transfer body 10 from the transfer target 20, as shown in FIG. 1(d), part or all of the transfer layer 12 and image layer 13 adhered on the transfer target 20 are peeled from the base layer 11 and remain on the transfer target 20, and the image is transferred onto the transfer target 20. The thickness of the transfer layer 12 or the performance of the transfer layer 12 being penetrated by ink is provided such that the image may be clearly seen from the exposed surface of the transfer layer 12 on which the ink printed on the transfer layer 12 remains on the transfer target 20, particularly such that the ink penetrates to the exposed surface or directly below the exposed surface.

For example, TEXCOL (trademark) (manufactured by Neenah Coldenhove) may be used as the transfer body 10.

### Composition of Ink for Printing Images

The ink for printing images is any inkjet ink that may be used for inkjet printing by a printing device 110 described later. Examples of such inks include general inkjet inks, latex inks, ultraviolet curable inks, sublimation inks, and the like. The coloring material contained in the ink is arbitrary, and may be a pigment such as an inorganic pigment or organic pigment, or may be a dye. Pigment ink has inferior color development but high washing fastness and friction fastness, and dye ink has inferior fastness compared to pigment ink but has good color development, so they may be used selectively according to the application. The ink may be water-based ink in which the solvent is water, particularly water-based pigment ink. Examples of water-based inkjet inks include printing pigment ink, sublimation printing ink, reactive ink, acid ink, and the like. Water-based ink has no impact on the environment or human body and has high safety. The ink may contain resin. Examples of such resins include water-based urethane resins, water-based acrylic resins, and the like. These resins assist the adhesion or bonding of the coloring material, particularly pigment, with the transfer layer 12 or the transfer target 20.

### Configuration of Transfer Target 20

The transfer target 20 is fabric such as woven fabric, knitted fabric, or non-woven fabric, and may be wound into a roll shape for storage and transportation. Examples of the material of the transfer target 20 include natural fiber such as cotton, silk, and hemp, and synthetic fiber such as polyester, nylon, and wool. The width of the transfer target 20 according to being wound into a roll shape is preferably 500 mm or more and 1800 mm or less.

### Configuration of Image Assignment System 100

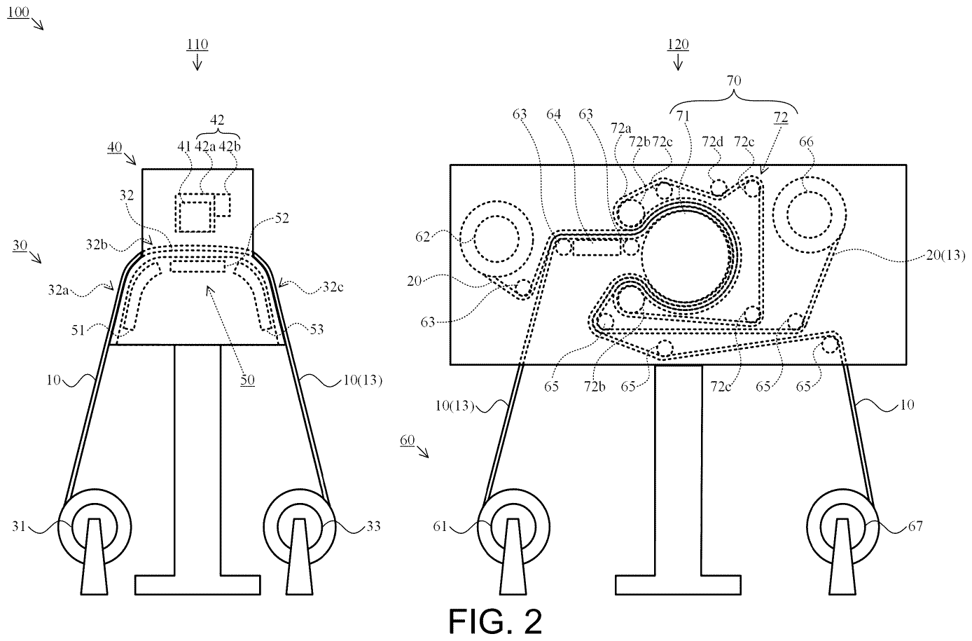

The image assignment system 100 includes a printing device 110 and a transfer device 120, as shown in FIG. 2. Furthermore, the image assignment system 100 also includes a control part that controls the printing device 110 and the transfer device 120. The operations of the printing device 110 and the transfer device 120 described below are performed under the control of the control part. Moreover, instead of or in addition to the control part that controls the entire image assignment system 100, a control part for controlling the operation of each of the printing device 110 and the transfer device 120 may be provided.

### Configuration of Printing Device 110

The printing device 110 is an inkjet printer that prints images on the transfer body 10 with the above-described ink by the inkjet method. The printing device 110 includes a transport mechanism 30, a printing part 40, and a heating part 50, as shown in FIG. 2.

The transport mechanism 30 transports the transfer body 10 along the transport direction (sub-scanning direction) by a roll-to-roll method, and causes the transfer body 10 to pass through the printing part 40. The transport mechanism 30 includes a feed roller 31 that feeds out a sheet of the transfer body 10 from a roll of the transfer body 10; a platen 32 that transports the fed transfer body 10 through the printing part 40; and a winding roller 33 that winds the sheet of the transfer body 10 on which the image layer 13 is formed, transported by the platen 32, into a roll shape. The transport mechanism 30 also includes, as necessary, one or more pinch rollers (not shown) for preventing the transfer body 10 from lifting off from one or more of the rollers and the platen.

The printing part 40 discharges ink onto the transfer body 10 being transported by the transport mechanism 30 to print an image. The printing part 40 includes an ink storage part (not shown), an ink supply mechanism (not shown), a print head 41, and a drive device 42 for the print head 41.

The ink storage part is composed of multiple tanks or bottles that store ink, and supplies these inks to the print head 41 via the ink supply mechanism.

The print head 41 discharges ink onto the transfer body 10 by the inkjet method. The inkjet method employed in the print head 41 is arbitrary, and for example, a piezo method or a thermal method may be considered. The print head 41 usually includes multiple nozzles that discharge ink, but may include only a single nozzle for each ink of each color. The print head 41 may be a single print head or may be composed of multiple print heads.

The drive device 42 of the print head 41 moves the print head 41 in a direction perpendicular to the transport direction of the transfer body 10 (main scanning direction). The drive device 42 includes, for example, a carriage 42a on which the print head 41 is mounted; a guide rail 42b that movably supports the carriage 42a in the main scanning direction; and a traction cable for the carriage 42a and a winding mechanism that winds the traction cable, which are arranged as a set at each end of the guide rail 42b.

The heating part 50 heats the transfer body 10 in parallel with printing on the transfer body 10 by the printing part 40. In a case where a part of the platen 32 that faces a region where the print head 41 discharges ink in main scanning operation is defined as a platen central part 32b, a part of the platen 32 that is upstream in the transport direction from the platen central part 32b is defined as a platen front part 32a, and a part of the platen 32 that is downstream in the transport direction from the platen central part 32b is defined as a platen rear part 32c, the heating part 50 includes a preheater 51 that heats the platen front part 32a; a print heater 52 that heats the platen central part 32b; and an after heater 53 that heats the platen rear part 32c. The preheater 51, the print heater 52, and the after heater 53 are platen heaters that heat the transfer body 10 sliding on the surface thereof to a predetermined temperature via heating of the platen 32. For example, such platen heaters include electric heaters using ceramics or nichrome wire.

The preheater 51 heats the transfer body 10 at a predetermined temperature, for example, 40 to 60° C., in order to shorten the time required for heating and drying by the print heater 52 and the after heater 53. The preheater 51 assists ink fixing by adjusting the water content of the transfer body 10 in high humidity environments. In addition, ink bleeding can be further suppressed by using the preheater 51 in combination with the print heater 52 or the after heater 53 rather than using the preheater 51 alone. However, the predetermined temperature for heating the transfer body 10 is not limited to these temperatures and may be appropriately set according to the purpose or the landing amount of ink.

The print heater 52 heats the transfer body 10 at a predetermined temperature, for example, 40 to 60° C., according to the purpose or the landing amount of ink. For example, heating is performed at 40 to 60° C. for the purpose of preventing ink bleeding, and at 50 to 60° C. for the purpose of preventing bleed-through or preventing show-through. By drying the ink printed on the transfer body 10 in this way, bleeding of the printed ink and transfer of ink to overlapping portions in response to the transfer body 10 being wound in a roll shape are suppressed or prevented. However, the predetermined temperature for heating the transfer body 10 is not limited to these temperatures and may be appropriately set according to the purpose or the landing amount of ink.

The after heater 53 heats the transfer body 10 at a predetermined temperature, for example, 40 to 60° C., according to the purpose or the landing amount of ink. For example, heating is performed at 40 to 60° C. for the purpose of preventing ink bleeding, and at 50 to 60° C. for the purpose of preventing bleed-through or preventing show-through. By drying the ink printed on the transfer body 10 in this way, bleeding of the printed ink and transfer of ink to overlapping portions in response to the transfer body 10 being wound in a roll shape are further suppressed or prevented. However, the predetermined temperature for heating the transfer body 10 is not limited to these temperatures and may be appropriately set according to the purpose or the landing amount of ink.

### Configuration of Transfer Device 120

The transfer device 120 is a thermal transfer roller machine that thermally transfers an image on the transfer body 10 to a transfer target 20. As shown in FIG. 2, the transfer device 120 includes a transport mechanism 60 and a heating pressurizing part 70.

The transport mechanism 60 transports the transfer body 10 on which the image layer 13 is formed and the transfer target 20 in a roll-to-roll method. In this process, the transport mechanism 60 feeds the transfer body 10 and the transfer target 20, which are overlapped such that the transfer layer 12 and the image layer 13 of the transfer body 10 are in contact with a target transfer surface of the transfer target 20, into the heating pressurizing part 70, and thereafter separates the transfer body 10 and the transfer target 20 that have come out from the heating pressurizing part 70 from each other. The transport mechanism 60 includes a feed roller 61 that feeds out a sheet of the transfer body 10 from a roll of the transfer body 10 on which the image layer 13 is formed; a feed roller 62 that feeds out a sheet of the transfer target 20 from a roll of the transfer target 20; one or more guide rollers 63 and a platen 64 that transport the transfer body 10 and the transfer target 20 thus fed out to the heating pressurizing part 70 in an overlapped state; one or more guide rollers 65 that transport the transfer body and the transfer target 20 that have come out from the heating pressurizing part 70 in different directions to separate them; a winding roller 66 that winds the sheet of the transfer target 20 to which the image layer 13 has been transferred into a roll shape; and a winding roller 67 that winds the used transfer body 10 into a roll shape. Additionally, the transport mechanism 60 includes, as necessary, one or more pinch rollers (not shown) for preventing the transfer body 10 and the transfer target 20 from lifting off from one or more of the rollers and the platen.

In order to thermally transfer an image from the transfer body 10 to the transfer target 20, the heating pressurizing part 70 applies a predetermined pressure (for example, 4 to 8 bar) to the transfer body 10 and the transfer target 20, which are overlapped such that the transfer layer 12 and the image layer 13 of the transfer body 10 are in contact with a target transfer surface of the transfer target 20, while heating the transfer layer 12 and the image layer 13 of the transfer body 10 to a predetermined temperature (a temperature at which the thermoplastic resin of the transfer layer 12 of the transfer body 10 softens (glass transition point or melting point), which also varies depending on the heat resistance of the transfer target 20, but for example, 100 to 200° C., more preferably 160 to 200° C.). The pressure and temperature are adjusted according to the thickness and heat resistance of the fabric of the transfer target 20. For example, this suppresses wasteful energy. The predetermined temperature may be, for example, a temperature higher than the glass transition temperature or melting point of the thermoplastic resin of the transfer layer 12 of the transfer body 10. The heating pressurizing part 70 includes a heating roller 71 and a pressurizing device 72.

The heating roller 71 rotates while sandwiching the transfer body 10 and the transfer target 20 between itself and a belt 72a of a heating device 72 described later, and heats the transfer layer 12 from the back surface of the transfer body 10 on the side opposite to the transfer layer 12 during the rotation process. The heating roller 71 includes, for example, a thermally conductive roller such as a metal roller, and an electric heater that indirectly heats the transfer body 10 in contact with the thermally conductive roller by heating the thermally conductive roller.

The pressurizing device 72 cooperates with the aforementioned heating roller 71 to transport the transfer body 10 and the transfer target 20 while sandwiching them between itself and the heating roller 71, and applies pressure to the transfer body 10 and the transfer target 20 from the transfer target 20 side during the transport process. The pressurizing device 72 includes a belt 72a wound around the heating roller 71; a drive roller 72b that drives the belt 72a at a speed compatible with the rotation speed of the heating roller 71; a driven roller 72c that supports the belt 72a so as to surround the heating roller 71; and a pressure roller 72d that adjusts the pressure applied by the belt 72a to the heating roller 71 and the transfer body 10 and transfer target 20 thereon. The pressure roller 72d increases or decreases the slack of the belt 72a by changing its position, that is, increases or decreases the distance between the belt 72a and the pressure roller 71, and adjusts the pressure applied by the belt 72a to the pressure roller 71.

The distance between the transfer body 10 and the transfer target 20 after they exit the heating pressurizing part 70 and when they are peeled off from each other is set to a length that allows the transfer body 10 and the transfer target 20 to be peeled off while the temperature of the transfer body 10, particularly the temperatures of the transfer layer 12 and the image layer 13, is a temperature suitable for peeling (so-called hot peeling) at a temperature higher than room temperature (e.g., 25° C.), for example, a temperature equal to or higher than the temperature at which the thermoplastic resin of the transfer layer 12 of the transfer body 10 softens, that is, a temperature at which the thermoplastic resin does not solidify. For example, the distance and the transport speed of the transfer body 10 and the transfer target 20 are preferably a distance and speed at which the transfer body 10 and the transfer target 20 are peeled immediately after exiting the heating pressurizing part 70, and preferably a distance and speed at which they are peeled at least while the thermoplastic resin of the transfer layer 12 is at a temperature at which it does not solidify.

### Control Part

The control part controls each device such that the printing device 110 and the transfer device 120 perform the above operations.

The control part includes a storage device (hard disk, flash memory, etc.) that stores programs and various data, a processor (CPU (Central Processing Unit), etc.) that executes programs stored in the storage device and actually executes printing processing by using various data, a main memory of the processor, and various interfaces. The control part may be configured by various computers such as a personal computer.

### Image Assignment Processing to Transfer Target

The control part causes the transport device 30 to transport the transfer body 10 along the transport path, and in the process, causes the printing part 40 to perform printing on the transfer body 10. After that, the transfer body 10 wound by the winding roller 33 is installed on the feed roller 61 of the transport device 60, for example, by a user. After that, the control part causes the transport device 60 to transport the transfer body 10 and the transfer target 20 along the transport path, overlays both, feeds them into the heating pressurizing part 70, peels the transfer body 10 and the transfer target 20 that have exited the heating pressurizing part 70, and finally causes the transfer body 10 to be wound by the winding roller 67 and the transfer target 20 to be wound by the winding roller 66. In this process, the control part causes the heating pressurizing part 70 to transfer the image from the transfer body 10 to the transfer target 20.

### Effects of the Present Embodiment

In conventional printing methods, in the case of sublimation printing, various treatments are required for color development and fixation of disperse dye, and harmful waste liquid may be generated during this process. The same was true for the DTG printing method. Also, in the case of the DTF printing method, since resin powder is used as an adhesive, harmful dust may be generated. Also, in the case of the rubber transfer printing method, in addition to printing images on the rubber sheet, excess rubber sheet must be cut off and finishing press must be performed, making the work process complicated and inefficient, and not suitable for scale printing. Also, an image assignment system capable of printing images on fabric on a large scale without adversely affecting the environment and human body or while suppressing adverse effects using the transfer sheet described in Patent Document 1 was not known. Also, in the case of the DTF printing method and rubber transfer printing method, various treatments are required to form a transfer body on which images are printed, which was complicated. Also, an image assignment system that efficiently assigns images to fabric with large width using the transfer sheet described in Patent Document 1 was not known.

On the other hand, according to the image assignment system 100 of the present embodiment, since the coloring material may be adhered or bonded to fabric by the thermoplastic resin included in the transfer layer 12 of the transfer body 10 without depending on the properties of the coloring material, part or all of the complicated processing conventionally required in transferring images to fabric may be omitted. Therefore, images may be efficiently assigned to fabric. Also, therefore, images may be printed on fabric on a large scale without adversely affecting the environment and human body or while suppressing adverse effects. For example, in the image assignment system 100 according to the present embodiment, after separating the transfer target 20 from the transfer body 10, there is no need to perform a process using water on the transfer target 20 or a process of discharging water.

### Modification Example 1

In the above-described embodiment, the transfer body 10 on which images are printed is wound into a roll shape by the winding roller 33 for the printing device 110, and then installed again on the feed roller 61 for the transfer device 120. Instead of this, the transfer body 10 on which images are printed may also be directly supplied from the printing device 110 to the transfer device 120 in a roll-to-roll method.

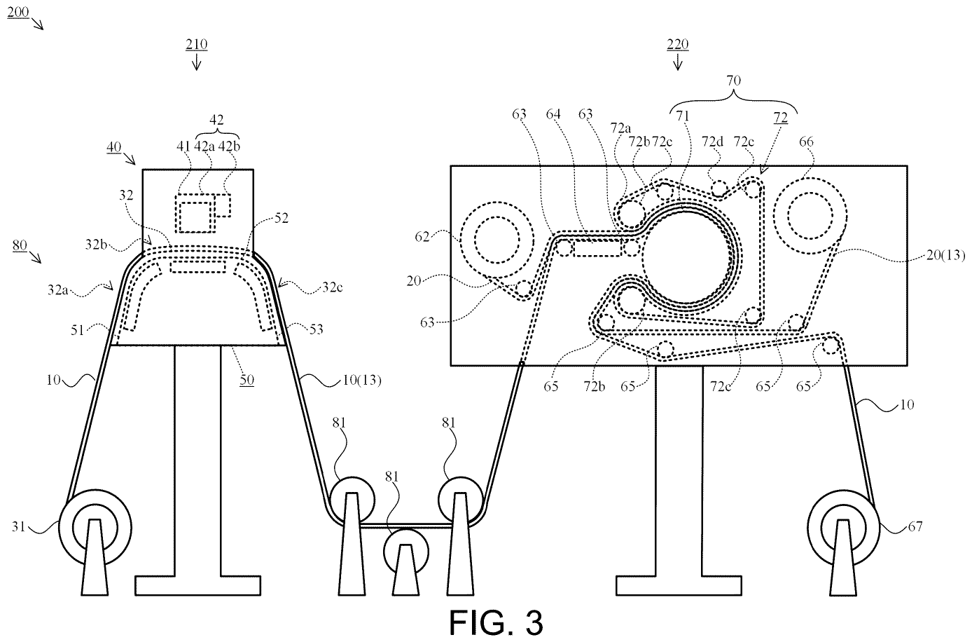

A printing device 200 according to the present modification example will be described with reference to FIG. 3. The printing device 200 includes a printing device 210 and a transfer device 220. The printing device 210 and the transfer device 220 are the same as the printing device 110 and the transfer device 120, except that they share a transport mechanism 80 in which both mechanisms are integrated instead of the transport mechanism 30 and the transport mechanism 60. The transport mechanism 80 is an integration of the transport mechanism 30 and the transport mechanism 60, and includes one or more guide rollers 81 instead of the winding roller 33 and the feed roller 61. The transport mechanism 80 transports the transfer body 10 in a roll-to-roll method, and causes the transfer body 10 to pass through the printing device 210 and the transfer device 220.

### Modification Example 2

In the above-described embodiment, the transfer body 10 and the transfer target 20 are supplied to the printing device 110 and the transfer device 220 from their rolls. Instead of this, one or both of the transfer body 10 and the transfer target 20 may be supplied in forms other than rolls. For example, the transfer target 20 may be supplied to the printing device 110 and the transfer device 220 in the form of fabric, textile products, etc. cut to predetermined dimensions. Also, the transfer body 10 may be supplied to the printing device 110 and the transfer device 220 in a form cut to a shape similar to the shape of the transfer target 20 or cut into a rectangle or square that fits within that shape, according to the shape of the transfer target 20.

Also, any transport mechanism may be adopted for the transport mechanisms 30, 60, 80 as long as the transfer body 10 and the transfer target 20 may be transported through the printing part 40 and the heating pressurizing part 70. For example, a belt conveyor may be adopted for part or all of the transport mechanism. The belt conveyor is suitable, for example, for transporting the transfer target 20 such as fabric, textile products, etc. cut to predetermined dimensions.

### Modification Example 3

Any inkjet printer may be adopted for the printing devices 110, 210, particularly for the printing part 40, as long as it may print images on the transfer body 10 by the inkjet method.

### Modification Example 4

In the above-described embodiment, the heating part 50 composed of the preheater 51, the print heater 52, and the after heater 53 is used, but it is sufficient to have either one of the print heater 52 and the after heater 53. Also, in order to obtain good drying results while preventing excessive drying of the image, the heating temperature of either one or both of the print heater 52 and the after heater 53, particularly the heating temperature of the print heater 52, may be adjusted according to the amount of ink discharged for printing the image, such that the temperature becomes higher in the case of a large amount of ink and the temperature becomes lower in the case of a small amount of ink. The heating temperature may be adjusted based on the amount of ink actually discharged, may be adjusted based on the estimated ink consumption from data of the image scheduled to be printed, or may be adjusted based on the ink consumption estimated from print density and/or the number of passes, etc.

Also, in the above-described embodiment, the heating part 50 composed of a platen heater is used, but any drying mechanism may be adopted instead as long as it may dry the transfer body 10 on which an image has been printed. For example, such drying mechanisms include air drying machines. Also, such drying mechanisms include a heating heater part that heats by contacting from the lower surface of the transfer body in at least a partial region on the transport path of the transfer body 10 during image printing by the printing device 110, or an air drying part that dries by blowing air from the upper surface of the transfer body to at least a partial region of the transfer body. The heating heater part includes, for example, a platen heater. The air drying part includes, for example, an air drying machine that blows air at a predetermined temperature. Here, the region to be dried may be a region where ink lands on the surface of the transfer body 10 (for example, a region corresponding to the platen central part 32b and the platen rear part 32c), a region where ink is dried simultaneously as it lands on the surface of the transfer body 10 (for example, a region corresponding to the platen central part 32b), or a region before ink is discharged onto the surface of the transfer body 10 (for example, a region corresponding to the platen front part 32a). Such drying mechanisms also function similarly to the above-described heating part 50, particularly the preheater 51, the print heater 52, and the after heater 53.

In order to suppress or prevent ink bleeding in the image, the drying mechanism is disposed on the transport path or in the vicinity of the transport path so as to be able to perform drying processing during printing by the printing device 110 or immediately after printing.

In order to suppress or prevent show-through of ink, the drying mechanism may dry the image to such an extent that the ink constituting the image does not adhere to the other surface between the time when the printing device 110 prints the image on the transfer body 10 and the time when the transfer body 10 contacts the other surface. Examples of the other surface include the surface opposite to the surface on which the transfer layer 12 is formed in the case of the printed transfer body 10 being wound by the winding roller 33, or the surface of the first guide roller 81 that contacts the transfer layer 12 of the printed transfer body 10 in the case of the printed transfer body 10 being transported by the transport mechanism 80. At this time, the drying mechanism is disposed on the transport path or in the vicinity of the transport path so as to be able to perform drying processing from during printing by the printing device 110 before ink contacts with such other surfaces. According to this modification example, since the ink is suitably dried before winding or transport, there is no need to separately provide time for natural drying of the ink, time can be saved, and images can be efficiently assigned to fabric.

### Modification Example 5

In the above-described embodiment, a thermal transfer roller machine composed of the heating roller 71 and the pressurizing device 72 is used as the transfer device 120, 220, but any transfer device may be adopted for the transfer device 120, 220 as long as it may transfer the image printed on the transfer layer 10 to the transfer target 20.

For example, a pressure roller may be adopted as the pressurizing device 72.

Also, a heat press machine may be adopted as the transfer device 120, 220.

### Modification Example 6

In the above-described embodiment, in the transfer device 120, 220, the transfer body 10 and the transfer target 20 that come out overlapping from the heating pressurizing part 70 are transported in different directions by the guide roller 65 to separate them, but instead of such a peeling mechanism, any peeling mechanism that separates the transfer body 10 and the transfer target 20 may be adopted.

Such a peeling mechanism is particularly suitable in the case of the transfer target 20 being discontinuous in the transport direction, for example, in the case of the transfer target 20 being fabric, textile products, etc. cut to predetermined dimensions.

### Modification Example 7

In the above-described embodiment, the transfer layer 12 is formed directly on the base layer 11, but instead of this, a release layer may be provided between the base layer 11 and the transfer layer 12 to facilitate peeling of the transfer layer 12 from the base layer 11. For example, in the case of peeling the transfer body 10 at a temperature (e.g., 100 to 160° C.) higher than room temperature (e.g., 25° C.) from the transfer target 20 (so-called hot peeling), examples of the material for the release layer include materials that melt at the heating temperature when the image is thermally transferred to the transfer target 20, as described above. For example, such melting materials include silicone, acrylate, wax, etc., and more preferably include polyolefin waxes such as polypropylene wax and polyethylene wax. The release layer may further include additional polymers or silicone, rheology modifiers, surfactants, binders, pigments, etc.

### Modification Example 8

The transfer body 10, the transfer target 20, and the ink for printing an image on the transfer body 10 may have ZDHC-MRSL Level 0 compliance, ZDHC-MRSL Level 1 compliance, ZDHC-MRSL Level 2 compliance, or ZDHC-MRSL Level 3 compliance, and particularly preferably have ZDHC-MRSL Level 3 compliance. In the case of all of the transfer body 10, the transfer target 20, and the ink for printing an image on the transfer body 10 having a certain level of ZDHC-MRSL compliance, there is a high probability that the textile product obtained by assigning an image to the transfer target 20 has the ZDHC-MRSL compliance of that level. Therefore, according to this modification example, it becomes easier for the user to obtain a predetermined level of ZDHC-MRSL compliance certification, for example, ZDHC-MRSL Level 3 compliance certification, for textile products manufactured using the image assignment system 100, 200.

The features described in the above-described embodiments and modification examples may be arbitrarily combined as long as they do not contradict each other.

### REFERENCE SIGNS LIST

100, 200 image assignment system
110, 210 printing device
120, 220 transfer device
10 transfer body
11 base layer
12 transfer layer
13 image layer
20 transfer target
30 transport mechanism for printing device
31 feed roller for transfer body 10 before printing
32 platen
32a platen front part
32b platen central part
32c platen rear part
33 winding roller for transfer body 10 after printing
40 printing part
41 print head
42 drive device
42a carriage
42b guide rail
50 heating part
51 preheater
52 print heater
53 after heater
60 transport mechanism for transfer device
61 feed roller for transfer body 10 before transfer
62 feed roller for transfer target 20 before transfer
63 guide roller
64 platen
65 guide roller
66 winding roller for transfer target 20 after transfer
67 winding roller for transfer body 10 after transfer
70 heating pressurizing part
71 heating roller
72 pressurizing device
72a belt
72b drive roller
72c driven roller
72d pressure roller
80 transport mechanism for both printing device and transfer device

1. An image assignment system for assigning an image to at least a partial region of a transfer target in a width direction of the transfer target having a width of 500 mm or more, the image assignment system comprising:
a transfer body that comprises a base layer and a transfer layer formed on one surface of the base layer;
a printing device that prints the image on the transfer layer by an inkjet method using ink containing a coloring material; and
a transfer device that transfers the image printed on the transfer layer to the transfer target by overlaying the transfer body with the transfer target and applying heat and pressure,
wherein the transfer layer comprises a thermoplastic resin that softens in response to reaching a glass transition temperature or a melting point.

2. The image assignment system according to claim 1,
wherein the ink further comprises a solvent, and
the printing device further comprises a drying mechanism that dries the transfer body on which the image is printed by evaporating the solvent.

3. The image assignment system according to claim 2,
wherein the drying mechanism comprises a heating heater part that contacts and heats the transfer body from a lower surface thereof in at least a partial region on a transport path of the transfer body during printing of the image, or an air drying part that dries by blowing air onto an upper surface of the transfer body against at least a partial region of the transfer body.

4. The image assignment system according to claim 2,
wherein the drying mechanism dries the image to such an extent that the ink constituting the image does not adhere to an other surface between when the printing device prints the image on the transfer body and when the transfer body contacts the other surface.

5. The image assignment system according to claim 3,
wherein the at least a partial region on the transport path of the transfer body is a region where the ink lands on a surface of the transfer body.

6. The image assignment system according to claim 5,
wherein in the at least a partial region on the transport path of the transfer body, the ink is dried simultaneously as it lands on the surface of the transfer body.

7. The image assignment system according to claim 3,
wherein the at least a partial region on the transport path of the transfer body is a region before the ink is discharged onto a surface of the transfer body.

8. The image assignment system according to claim 1,
wherein the transfer target is a sheet of natural fiber or synthetic fiber.

9. The image assignment system according to claim 1,
wherein the ink is a water-based ink, and
the coloring material is an inorganic pigment or an organic pigment.

10. The image assignment system according to claim 1,
wherein the transfer device performs transfer by applying a temperature higher than the glass transition temperature or the melting point of the thermoplastic resin of the transfer layer.

11. An image assignment system for assigning an image to fabric, the image assignment system comprising:
a transfer body that comprises a base layer and a transfer layer formed on one surface of the base layer;
a printing device that prints the image on the transfer layer by an inkjet method using a water-based ink containing a coloring material; and
a transfer device that transfers the image printed on the transfer layer to the fabric by overlaying the transfer body with the fabric,
wherein the transfer layer comprises a thermoplastic resin that softens in response to reaching a glass transition temperature or a melting point.

12. The image assignment system according to claim 11,
wherein the fabric, the transfer body, and the water-based ink are ZDHC-MRSL Level 3 compliant.

13. The image assignment system according to claim 11,
wherein after separating the fabric from the transfer body after transfer,
no step of using water on the fabric or no step of discharging water is performed.

14. The image assignment system according to claim 11
wherein the fabric is natural fiber or synthetic fiber.

15. The image assignment system according to claim 11, wherein the coloring material is an inorganic pigment or an organic pigment.

16. An image assignment method for assigning an image to fabric, the image assignment method comprising:
printing the image on a transfer layer of a transfer body by an inkjet method using a water-based ink containing a coloring material; and
transferring the image printed on the transfer layer to the fabric by overlaying the transfer body with the fabric,
wherein the transfer layer comprises a thermoplastic resin that softens in response to reaching a glass transition temperature or a melting point.

17. The image assignment method according to claim 16,
wherein the fabric, the transfer body, and the water-based ink are ZDHC-MRSL Level 3 compliant.

18. The image assignment method according to claim 16,
wherein after separating the fabric from the transfer body after transfer,
no step of using water on the fabric or no step of discharging water is performed.

19. The image assignment method according to claim 16,
wherein the fabric is natural fiber or synthetic fiber.

20. The image assignment method according to claim 16, wherein the coloring material is an inorganic pigment or an organic pigment.
